(19) United States
(12) Patent Application Publication
(10) Pub. No.: US 2006/0131425 A1
(43) Pub. Date: Jun. 22, 2006

(54) Value document comprising a machine-readable authenticity mark

(75) Inventors: Gerhard Stenzel, Muenchen (DE); Wittich Kaule, Emmering (DE); Gerhard Schwenk, Puchheim (DE)

Correspondence Address: ROTHWELL, FIGG, ERNST & MANBECK, P.C., 1425 K STREET, N.W., SUITE 800, WASHINGTON, DC, 20005, US

(73) Assignee: Giesecke & Devrient Gmbh, Muenchen (DE)

(21) Appl. No.: 10/560,114

(22) PCT Filed: Jun. 4, 2004
(86) PCT No.: PCT/EP04/06066

§ 371 Date: Dec. 9, 2005

(30) Foreign Application Priority Data
Jun. 12, 2003 (DE) 10326983.5

(51) Int. Cl. G06K 19/06; G06K 7/10; G07F 19/00

(52) U.S. Cl. 235/491; 235/468; 235/379

(57) ABSTRACT

The invention relates to a value document having a machine-readable authenticity mark. According to the invention the authenticity mark comprises a luminescent marking substance and a marking substance absorbing in the infrared spectral range.

This invention relates to a value document, a security element and a security paper having a machine-readable authenticity mark. The invention also relates to different methods for checking the authenticity of such value documents, a security element or a security paper.

Value documents, such as bank notes, shares, bonds, certificates, coupons, checks, high-quality admission tickets, as well as other papers at risk of forgery, such as passports or other identification documents, are normally provided with various security features to increase their falsification security. The security feature used is for example a security thread embedded in the bank note, an applied security stripe or a self-supporting transfer element, such as a patch or label, which after its production is applied to a value document.

It is also known to provide value documents or high-priced goods with markings which are largely invisible under ordinary conditions and detectable when illuminated by radiation outside the visible spectral range. For example, the print EP 0 340 898 A2 describes a security coding which appears colorless or only weakly colored in the visible spectral range and which has a significant absorption in the near infrared, in particular at a wavelength between 750 nm and 1000 nm. To make recognition of the security coding more difficult with the naked eye, it is overprinted with a second color marking which is colored in the visible spectral range and transparent. in the infrared spectral range.

For reading out the security coding, infrared detectors are used which are sensitive in the wavelength range from 780 nm to 800 nm and can detect the infrared absorption of the security coding. Such infrared detectors are now customary and widespread. The protection from forgery provided by the described security coding can therefore no longer be rated especially high, since the part of the coding invisible to the human eye is also detectable by anyone without special effort. This results in starting points for unauthorized imitations or copies of the security coding of EP 0 340 898 A2.

It is of special advantage when a security feature is machine-readable, since this permits automatic authenticity testing of a large number of value documents to be carried out within a short time, for example in a bank note processing machine. Furthermore, it is often desirable for a document or protected object to be checked unobtrusively or without the owner recognizing it, which as a rule can only be done with the help of a machine-readable security feature.

On these premises, the present invention is based on the problem of specifying an authenticity mark for value documents and other objects to be secured which avoids the disadvantages of the prior art and ensures increased falsification security. Furthermore, the authenticity mark should be machine-readable.

This problem is solved by the value document with the features of the main claim. A security element for securing an object, a security paper for producing security or value documents, methods for authenticity testing of the stated objects, and an apparatus for carrying out the authenticity testing are the subject matter of the independent claims. Developments of the invention are subject matter of the subclaims.

The inventive value document, security element and security paper are based on the prior art in that the authenticity mark comprises a luminescent marking substance and a marking substance absorbing in the infrared spectral range. It has turned out that when only one marking substance is used it is relatively easily possible to analyze and imitate the authenticity mark, since only one property of the marking substance must always be recognized and imitated. However, if several substances are combined which have the same or very similar effects, for example different fluorescences, the two properties can influence each other upon detection, so that successful detection can no longer be ensured in every case.

In contrast, the marking substances do not disturb each other in the inventive combination, since different substance properties are scanned upon detection. Further, the infrared absorbing marking substance does not deliver an active signal for analysis of the contained substances, which makes analysis considerably more difficult for the forger. The analysis or imitation of luminescent marking substances is comparatively simple, however, since the emitted radiation can easily be made visible by irradiating a wide spectral range.

In other embodiments described in more detail below, precisely the interaction of the two substance properties is used as the basis for evaluation in authenticity testing. The effects arising from the interaction of the two marking substances cannot be imitated in a simple way and therefore offer particularly high falsification security.

According to an advantageous embodiment of the invention, the luminescent marking substance emits in the infrared spectral range, preferably at a wavelength λ above about 1100 nm, particularly preferred above about 1200 nm. This has the advantage that the luminescence can then not be detected with conventional and readily available infrared detectors, which are mainly sensitive in the wavelength range from 780 to 800 nm. Conventional silicon photodiodes do not permit detection of infrared radiation with wavelengths above about 1100 nm due to the band gap of silicon of 1.12 eV. Detectors for longer-wave infrared radiation are fundamentally more elaborate and not available to everyone.

It has in particular proved expedient if the luminescent marking substance emits in the absorption range of the infrared absorbing marking substance. This permits the above-mentioned interaction effects of the two marking substances to be utilized. Excitation of the luminescent marking substance is advantageously likewise effected in the infrared spectral range, preferably in the spectral range from about 800 nm to about 1000 nm.

According to an advantageous development of the invention, the infrared absorbing marking substance is essentially colorless or has only weak inherent color in the visible spectral range. It is then invisible or appears only inconspicuously under ordinary lighting conditions. In particular, the infrared absorbing marking substance can be transparent in the visible. Even at a wavelength of about 800 nm, the infrared absorbing marking substance advantageously still has no significant absorption in order to escape detection by customary infrared detectors.

The infrared absorbing marking substance has a significant absorption preferably only in the spectral range between about 1200 nm and about 2500 nm, preferably in the spectral range between about 1500 nm and about 2000 nm. The infrared absorption of the authenticity mark is then not detectable at the wavelengths of conventional infrared detectors, but emerges only in the longer-wave and more poorly accessible spectral range above 1200 nm, or above 1500 nm.

Preferred infrared absorbing marking substances have in the visible spectral range less than about 40%, in particular less than about 25%, of the absorption in the range from 1200 nm to 2500 nm or in the range from 1500 nm to 2000 nm, based in each case on the area under the absorption curve for the particular spectral range.

The infrared absorbing marking substances used in accordance with the present invention are for example substances based on doped semiconductor materials. Substances containing a metal oxide are also suitable. These substances are characterized in particular by their aging resistance. The infrared absorbing marking substance is preferably present in particle form with an average particle size smaller than 50 μm. This means that visible light is hardly scattered by the particles, so that the marking substance is colorless or has only weak inherent color.

Some examples of infrared absorbers having no appreciable absorption either in the visible or at about 800 nm are 2,5-cyclohexadiene-1,4-diylidene-bis[N,N-bis(4-dibutylaminophenyl)ammonium]bis(hexafluoroantimonate) with the totals formula C₆₂H₉₂N₆F₁₂Sb₂, or the dyes ADS 990 MC with the totals formula C₃₂H₃₀N₂S₄Ni or ADS 1120P with the totals formula C₅₂H₄₄Cl₂O₆ from Siber Hegner GmbH, Hamburg.

The luminescent marking substance can be formed on the basis of a host lattice doped with a rare earth metal. Some examples of such luminescent marking substances can be found in the print WO 99/38701, whose disclosure is included in the present application in this respect.

In a preferred embodiment of the invention, the luminescent marking substance and the infrared absorbing marking substance are formed by separate substances which are incorporated into the value document or applied to the value document separately from each other. This permits great flexibility in the selection of the two marking substances in order to fulfill different and partly contrary requirements, for example regarding security, age resistance, wear resistance and production costs.

Alternatively, the luminescent marking substance and the infrared absorbing marking substance are incorporated into the value document or applied to the value document jointly as a mixture of substances. This variant likewise offers important advantages, since the mixture of substances can be applied by a single printing cycle. This results, for example in bank-note printing, in considerably lower restrictions in bank-note design than when two separately applied marking substances are used. In the latter case a visible printing cycle must often be omitted, or a costly additional printing cycle carried out on a further printing mechanism.

Furthermore, a uniform and high coverage of up to about 50% can be obtained by admixing the luminescent marking substance to an invisible infrared absorbing feature, such as a bar code, applied over a large area. In contrast, with conventional admixture to the visible printing ink, the detection of luminescent marking substances is often impaired by the colored pigments of the ink. Also, the distribution of the marking substance is very non-uniform due to the different printed images for bank notes with different denominations.

As a further advantage of the combination of the two marking substances in a mixture of substances, a testing step can be omitted in the quality control of the invisible print. For example, with infrared absorbing bar codes, the control of the print quality of the bar codes ensures that the right line width of the ink is printed. The quality control of the admixed luminescent marking can then be confined to the incoming inspection of the ink.

In an advantageous embodiment, the luminescent marking substance is incorporated into the value document or applied to the value document, for example printed, all over. The luminescent marking substance then provides a uniform background for an absorption or emission measurement, which can be used for example as a constant reference signal in authenticity testing. It is also possible, however, to incorporate or apply the luminescent marking substance only at selected places, for example along predetermined tracks.

The value document can comprise a substrate, in particular a paper substrate, in whose volume the luminescent marking substance is incorporated. Suitable methods for this purpose are for example those according to the prints EP-A-0 659 935 and DE 101 20 818, whose disclosures are included in the present application in this respect. The pigment particles used for the marking are admixed here to a gas stream or liquid stream and incorporated into a paper web. The methods are suitable in particular for marking security paper which is used for producing security or value documents, such as bank notes, identity cards or the like.

Alternatively or additionally, the luminescent marking substance can be added to a coating mixture or be applied together with a surface sizing to the surface of a value document or to the substrate materials used for production thereof. Besides paper and other fibrous substances, it is in particular also suitable to use foils for producing value documents into which the luminescent marking substance can likewise be incorporated, for example by coextrusion.

The infrared absorbing marking substance is preferably applied to the value document, being in particular printed on the value document. All suitable printing processes can be used for such printing. Ink jet printing is particularly preferred, since it also permits curved surfaces to be printed in a simple way and it is easily possible to individualize the print for different objects.

In accordance with an advantageous further development of the invention, the arrangement of the infrared absorbing marking substance represents information, such as patterns, signs or codings. The information is preferably present encrypted. The represented information can be for example a logo, a national emblem, writing or a letter/number combination.

It is particularly preferred for the arrangement of the infrared absorbing marking substance to form a bar code. In the context of the present invention, the term “bar code” includes any one- or two-dimensional pattern of black bars and white bars (spaces). The bar/space sequence normally represents a binary number sequence. The bar code can be read for example with an optoelectronic scanner by the radiation of a light-emitting or laser diode being guided across the bars and the scattered light received by a photodetector and supplied to an evaluation unit which extracts the coded information from the obtained pulse sequence. Bar codes can be read very well by machine and deliver an almost fault-free read result, in particular in connection with check digits.

Bar codes that can be used are universal formats like code 2/5, code 2/5 interleaved, code 128 or code 39, but also special formats like the codings UPC, EAN-8 or EAN-13 widespread in retail trade. Two-dimensional bar codes, which offer a particularly condensed recording, can also be used advantageously in the context of the invention. By way of example, code 2/5 interleaved will be described, which is used for strictly numeric codings. It uses five elements (bars or spaces) per character. Two of these five are wide elements, the other three elements are narrow. Characters at an even position are represented by a space and at an odd position by a bar.

Other codes, like code 39, which uses a bar code representation comprising 9 elements (5 bars and 4 spaces), three of which are wide and six narrow, permit both numbers and letters to be represented. For example, they can be used to code a bank note with the national currency (EUR, USD, etc.) and denomination figures or other data, such as the emission date of the bank note.

In a preferred embodiment of the invention, the luminescent marking substance and the infrared absorbing marking substance are present in overlapping areas of the value document. Then the partial absorption of the luminescence emission by the infrared absorbing marking substance can for example be used as an indirect readout operation difficult to imitate.

According to an advantageous development of the invention, the value document has a printed layer which partly or completely covers the areas of the value document provided with the infrared absorbing marking substance. In particular the printed layer can be opaque in the visible spectral range and transparent or translucent in the absorption range of the infrared absorbing marking substance, so that it conceals the presence of the infrared absorbing marking in the visible but does not hinder detection of infrared absorption at a test wavelength.

The printed layer can in particular be opaque in the emission range of the luminescent marking substance in order to permit a differentiated readout of an infrared absorbing marking, as described below.

In accordance with a further advantageous embodiment, the printed layer is applied to the value document by an intaglio printing technique.

The machine-readable authenticity mark is advantageously formed over a large area, in particular with a surface area of 100 mm² or more, preferably with a surface area of 400 mm² or more. Such a large-area authenticity mark is particularly suitable for marking bank notes, since most money processing machines have transport belts which cover parts of the bank note. Furthermore, large-area marks can be read more easily and with more reasonably priced reading devices. A larger surface is also of advantage for the infrared luminescent part of the authenticity mark.

To facilitate detection, the infrared absorbing marking substance and/or the luminescent marking substance is incorporated in the authenticity mark with a coverage of 30% or more, preferably about 50%.

Besides the described value document, the invention comprises a security element for securing an object having a machine-readable authenticity mark of the kind described above in connection with the value document. The security element can in particular be disposed detachably on a carrier layer. According to preferred embodiments, the security element is formed as a label, seal, transfer band, sleeve or other flat transfer element, and can be applied to any objects to be secured, for example packings or wrappings but also papers of value and other security documents.

The invention also comprises a security paper for producing security or value documents, such as bank notes, identity cards or the like, having a machine-readable authenticity mark as described above in connection with the value document.

A method for checking the authenticity of a value document, security element or security paper of the described type is characterized by the following steps:
irradiating the machine-readable authenticity mark with infrared radiation from the excitation range of the luminescent marking substance,
determining the emission of the authenticity mark at a wavelength from the emission range, and
evaluating the authenticity of the value document, security element or security paper on the basis of the determined emission.

To permit information coded in the authenticity mark to be extracted, the determination of emission is advantageously carried out in spatially resolved fashion. According to a preferred method variant, the emission of the authenticity mark is determined on two opposite sides of the value document, security element or security paper. The signal from one side, for example the back of a bank note, can then be used as a reference signal relative to which the signal from the other side, for example the front, can be evaluated. In particular, authenticity evaluation can be carried out on the basis of a comparison of the emission from the opposite sides.

Another inventive method for checking the authenticity of a value document, security element or security paper comprises the steps of:
irradiating the machine-readable authenticity mark with infrared radiation from the absorption range of the infrared absorbing marking substance,
determining the absorption of the authenticity mark at a wavelength from the irradiation range, and
evaluating the authenticity of the value document, security element or security paper on the basis of the determined absorption.

The absorption of the authenticity mark is advantageously determined here via a measurement, in particular a spatially resolved measurement, of the transmitted and/or remitted infrared radiation.

It is obvious that the two stated methods can also be combined with each other to evaluate the measurements from more than one security feature.

A further inventive method for checking the authenticity of a value document, security element or security paper is characterized by the following steps:
irradiating the machine-readable authenticity mark with infrared radiation from the excitation range of the luminescent marking substance,
determining the absorption of the authenticity mark at a wavelength from the absorption range of the infrared absorbing marking substance, and
evaluating the authenticity of the value document, security element or security paper on the basis of the determined absorption.

This method variant is based on an interaction between the two marking substances. The method presupposes that the excited luminescent marking substance emits in the absorption range of the infrared absorbing marking substance. The absorption is then not determined via a remission or transmission measurement but shows itself after excitation of the luminescent marking substance in a locally suppressed luminescence emission.

In this case, too, the absorption measurement is preferably carried out in spatially resolved fashion. It is obvious that this variant can also be combined with the two above-described methods.

In all three described methods, the absorption of the authenticity mark can additionally be determined at a wavelength from the visible spectral range for authenticity testing. It can thus be ensured for example that the infrared absorbing marking substance is not replaced by a simple infrared absorber, which can also be recognized in the visible.

The irradiation of the authenticity mark is advantageously carried out with a light-emitting diode or laser diode. Laser diodes are especially suitable, for example with an emission wavelength of 1550 nm.

If the arrangement of the infrared absorbing marking substance represents information, in particular a bar code, which is read by determination of the absorption or emission and used for authenticity testing, the information comprises, in a particularly preferred method variant, the denomination, the currency, the emission date, the country, the printing works, or special features of the value document or security element, and one or more of the stated pieces of information are read and processed further in authenticity testing.

The described methods can be advantageously carried out in particular with a money processing machine, a bank note counting machine, a bank note sorting machine, a bank note reading device for the blind or partially sighted, a bank note reading device for dealings in foreign currency, or a pocket-size bank note testing device.

The use of an infrared absorbing marking has essential advantages over conventional fluorescent codings. Firstly, the automatic readability of the marking is considerably less disturbed by a background print therebelow. Secondly, soiling is considerably less disturbing in the infrared spectral range than in the visible and the ultraviolet spectral ranges. The signal-to-noise ratio of a measuring head is also considerably better in remission measurements than in fluorescence measurements, so that higher resolution can be obtained.

Further embodiments as well as advantages of the invention will be explained hereinafter with reference to the figures. For more clarity, the figures do without a representation that is true to scale and to proportion. They show:

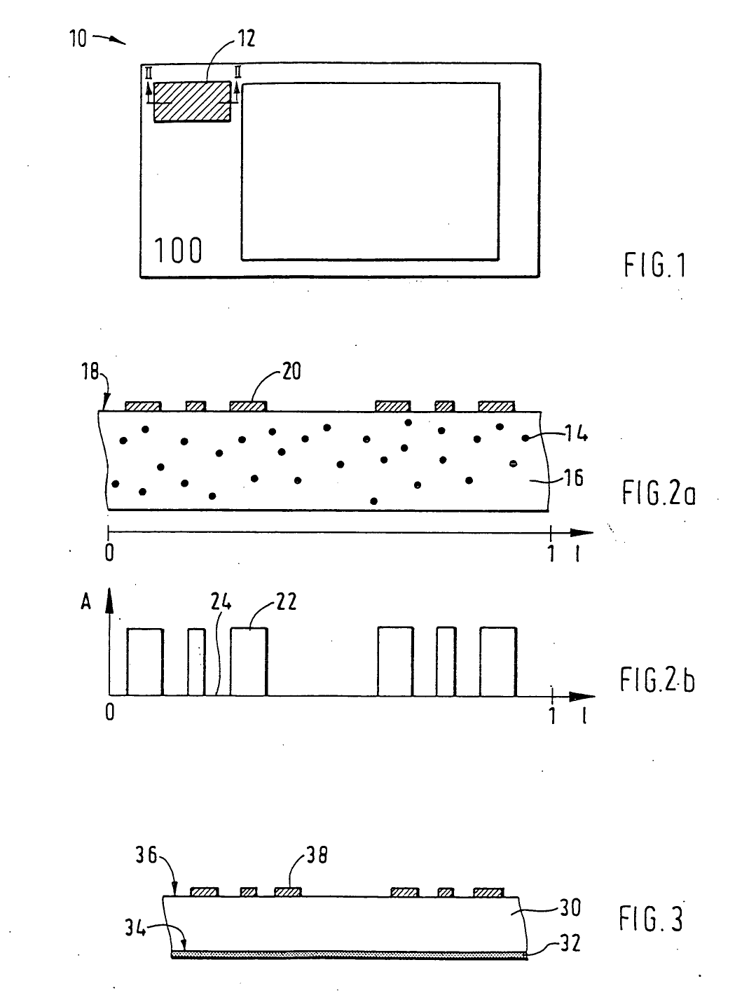

FIG. 1 a schematic representation of a bank note having a machine-readable authenticity mark according to one embodiment of the invention,

FIG. 2 (a) a cross section of the bank note of FIG. 1 in the area of the authenticity mark along line II-II, and
(b) the course of the infrared absorption of the authenticity mark along length 1 indicated in (a),

FIG. 3 a detail of the cross section of a value document with a luminescent coating according to another embodiment of the invention,

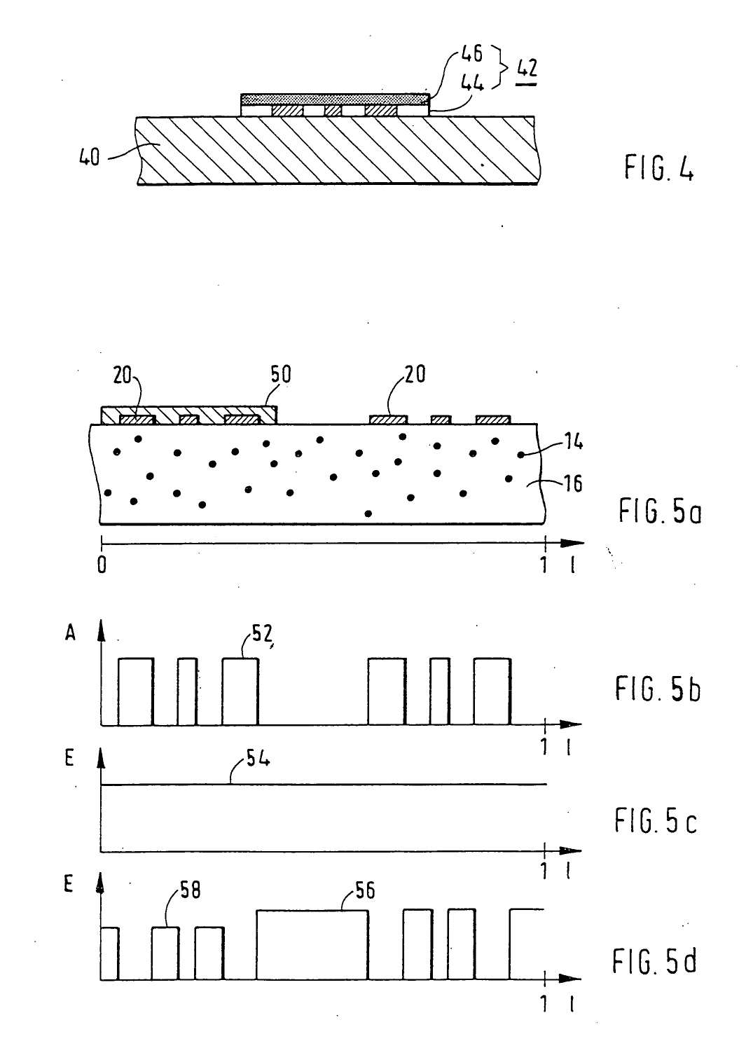

FIG. 4 an object of value with a glued-on security element according to a further embodiment of the invention in cross section, and

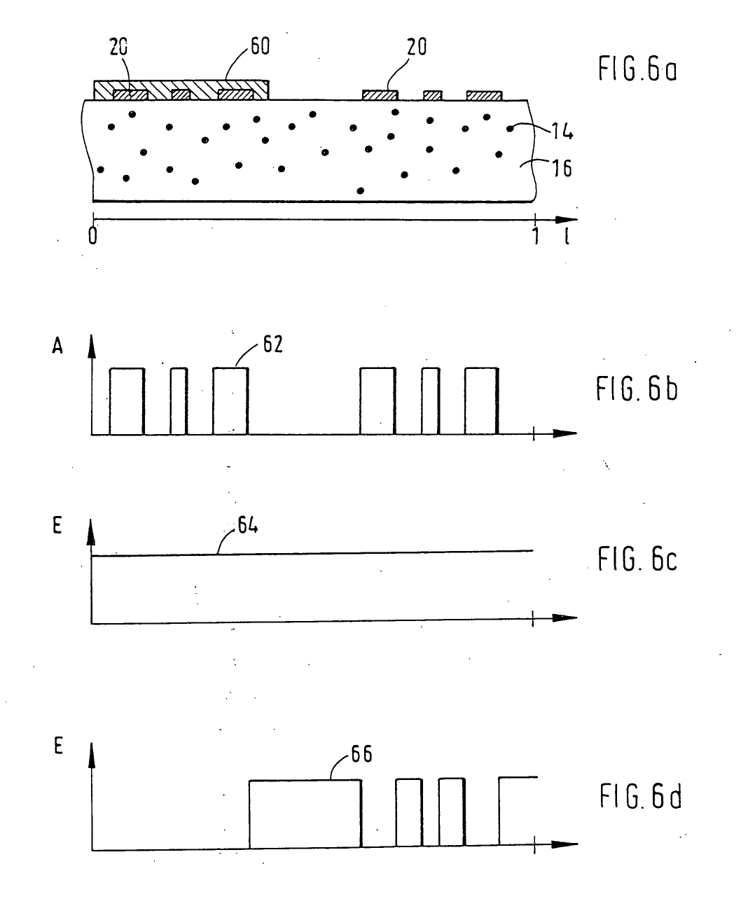

FIGS. 5 and 6 (a) a cross section through a bank note as in FIG. 1, each according to a further embodiment of the invention,
(b) the course of the infrared absorption measured on the front of the bank note,
(c) the course of the luminescence emission measured on the back of the bank note, and
(d) the course of the luminescence emission measured on the front of the bank note, in each case along the length 1 of the authenticity mark indicated in (a).

The invention will be explained hereinafter by the example of a bank note. FIG. 1 shows a schematic representation of a bank note 10 provided with a machine-readable authenticity mark in a partial area 12. The structure of the authenticity mark can be recognized best in the cross section of the partial area 12 shown in FIG. 2(a).

The authenticity mark comprises a marking substance luminescent in the infrared spectral range and incorporated in the form of particles 14 into the volume of the mat-like bank note substrate 16. The particles 14 can be added to the paper or fibrous pulp before sheet formation, or incorporated into the fibrous matrix after layer formation. In this embodiment, the luminescent particles 14 are distributed essentially uniformly through the substrate volume.

The authenticity mark further comprises an infrared absorbing marking substance printed on the front 18 of the bank note in form of a bar code 20 in the partial area 12. The bar code 20 contains, via a fixed bar coding, a unique identification of the national currency, denomination figures as well as a statement of the emission year of the bank note. The infrared absorbing marking substance is transparent in the visible spectral range up to wavelengths of about 800 nm, so that the presence of the bar code 20 and in particular its information content cannot be recognized by the user with the naked eye. Since the infrared absorbing bar code 20 is furthermore likewise transparent in the near infrared, it cannot be detected with customary infrared detectors based on silicon, which are sensitive at about 800 nm, either.

However, the absorption of the bar code 20 can be detected with more elaborate infrared detectors at a wavelength of 1550 nm by a remission measurement. FIG. 2(b) shows schematically the course of the measured infrared absorption along length 1 indicated in FIG. 2(a). The maximum values 0 and 1 show the limits of the partial area 12. If the coding scheme is known, for example code 39 is used, the information coded in the bar code 20 can be read from the position and width of the absorption peaks 22 and the absorption spaces 24. The infrared luminescence of the luminescent marking substance 14 can be checked on the front or back of the bank note 10 as an additional authenticity feature.

Another possibility of equipping a value document with the luminescent marking substance is shown in FIG. 3. Here, the luminescent marking substance is not disposed in the volume of the paper-of-value substrate 30 but applied to the back 34 of the substrate in form of a luminescence coating 32. The luminescence coating 32 may be a coating mixture with admixed luminescent particles, a surface sizing, a covering paint, a lacquer layer or a cover foil. An infrared absorbing bar code 38 is printed on the front 36 of the substrate, as described above.

FIG. 4 shows an object 40 to be secured having a glued-on security element 42 which was transferred to the object 40 from a transfer foil. The security element 42 comprises an infrared absorbing layer 44 with an infrared absorbing marking substance of the above-described type and a luminescence layer 46 disposed congruently thereabove. The luminescent marking substance of the luminescence layer 46 is chosen so that it is transparent at the test wavelength of 1550 nm at which the infrared absorbing layer 44 absorbs, so that the information coded in the layer 44 can be read by a spatially resolved measurement of the reflected infrared radiation. In the visible spectral range the presence of the infrared absorbing layer 44 is hidden by the luminescence layer 46.

A further embodiment of an inventive bank note is shown in FIG. 5. FIG. 5(a) shows a cross section in the area of the authenticity mark of the bank note as in FIG. 2(a). The same elements are provided with the same reference signs. The bank note of FIG. 5 differs from the embodiment of FIG. 2 primarily in the print 50 executed by intaglio printing with a printing ink which is opaque in the visible spectral range, but transparent at the test wavelength of the infrared absorbing marking substance, in this embodiment 1550 nm. Intaglio printing generally also leads to a tactilely perceptible relief structure with strong embossing in the printed area 50, which for simplicity's sake is not shown in the Figure.

The print 50 covers in particular a part of the infrared bar code 20, so that in this case it is also possible to use an infrared absorbing marking substance which is not, or not completely, transparent in the visible. A part of the bar code 20 is then visible, but another part is concealed by the print 50. An attempt at forgery by reproducing the visible part of the bar code 20 will then become apparent at the latest upon measurement of the overprinted part of the bar code 20.

A measurement of the infrared absorption on the front of the bank note along length 1 of the authenticity mark is shown in FIG. 5(b). Since the print 50 is transparent at the test wavelength, essentially the same absorption course 52 results as in the embodiment of FIG. 2.

FIG. 5(c) shows the course of the luminescence emission measured on the back of the bank note at a test wavelength of 1550 nm after excitation with infrared radiation in the wavelength range from 800 nm to 1000 nm. A constant emission signal 54 results, which can serve as a reference for front-side measurement. FIG. 5(d) finally shows the luminescence emission measured on the front of the bank note. At the places where bars of the bar code 20 are disposed, the luminescence radiation is absorbed by the infrared absorbing marking substance, so that corresponding spaces appear in the measured luminescence profile 56. In the spaces of the bar code 20 the luminescence can be reduced (reference sign 58) compared to the value outside the print 50, depending on the permeability of the printing ink.

FIG. 6 shows yet another embodiment of an inventive bank note in which, as a variation on the embodiment of FIG. 5, the luminescent marking substance 14 emits at about 1310 nm. The infrared absorbing bar code 20 absorbs both at 1310 nm and at the test wavelength of 1550 nm. The print 60 applied by intaglio printing is transparent to the test wavelength of 1550 nm, but absorbs both in the visible spectral range and at the emission wavelength of the luminescent marking substance.

The result upon the infrared absorption measurement shown in FIG. 6(b) at the test wavelength of 1550 nm on the front of the bank note is thus a course 62 as in FIG. 5(b), wherein the absorption is given by the distribution of the bars and spaces of the bar code 20.

The course of the luminescence emission measured on the back of the bank note at a wavelength of 1310 nm is shown in FIG. 6(c). Here the result is a constant reference signal 64, as in FIG. 5(c). FIG. 6(d) finally shows the luminescence emission 66 measured on the front of the bank note at a wavelength of 1310 nm. The luminescence radiation is absorbed both by the bars of the bar code 20 and by the print 60, so that at these places no luminescence can be measured.

1. A value document having a machine-readable authenticity mark, characterized in that the authenticity mark comprises a luminescent marking substance emitting in the infrared spectral range, and a marking substance absorbing in the infrared spectral range.

2. The value document according to claim 1, characterized in that the luminescent marking substance emits in the absorption range of the infrared absorbing marking substance.

3. The value document according to claim 1, characterized in that the luminescent marking substance is excitable in the infrared spectral range.

4. The value document according to claim 1, characterized in that the infrared absorbing marking substance is essentially colorless or has only weak inherent color in the visible spectral range.

5. The value document according to claim 1, characterized in that the infrared absorbing marking substance significantly absorbs in the spectral range between about 1200 nm and about 2500 nm.

6. The value document according to claim 1, characterized in that the infrared absorbing marking substance has no significant absorption at a wavelength of about 800 nm.

7. The value document according to claim 1, characterized in that the infrared absorbing marking substance comprises a doped semiconductor material or a metal oxide.

8. The value document according to claim 1, characterized in that the infrared absorbing marking substance is present in particle form with an average particle size smaller than 50 μm.

9. The value document according to claim 1, characterized in that the luminescent marking substance is formed on the basis of a host lattice doped with a rare earth metal.

10. The value document according to claim 1, characterized in that the luminescent marking substance and the infrared absorbing marking substance are formed by substances incorporated into the value document or applied to the value document separately from each other.

11. The value document according to claim 1, characterized in that the luminescent marking substance and the infrared absorbing marking substance are incorporated into the value document or applied to the value document jointly as a mixture of substances.

12. The value document according to claim 1, characterized in that the luminescent marking substance is incorporated into the value document or applied to the value document all over.

13. The value document according to claim 1, characterized in that the value document comprises a substrate, into whose volume the luminescent marking substance is incorporated.

14. The value document according to claim 1, characterized in that the infrared absorbing marking substance is applied to the value document.

15. The value document according to claim 1, characterized in that the arrangement of the infrared absorbing marking substance represents information.

16. The value document according to claim 15, characterized in that the information is present encrypted.

17. The value document according to claim 16, characterized in that the luminescent marking substance and the infrared absorbing marking substance are present in overlapping areas of the value document.

18. The value document according to claim 17, characterized in that the value document has a printed layer which partly or completely covers the areas of the value document provided with the infrared absorbing marking substance.

19. The value document according to claim 18, characterized in that the printed layer is opaque in the visible spectral range and is transparent or translucent in the absorption range of the infrared absorbing marking substance.

20. The value document according to claim 18, characterized in that the printed layer is opaque in the emission range of the luminescent marking substance.

21. The value document according to claim 18, characterized in that the printed layer is applied by an intaglio printing technique.

22. The value document according to claim 1, characterized in that the machine-readable authenticity mark is formed over a large are.

23. The value document according to claim 1, characterized in that the infrared absorbing marking substance and/or the luminescent marking substance is incorporated in the authenticity mark with a coverage of 30% or more.

24. A security element for securing an object having a machine-readable authenticity mark of a value document as described in claim 1.

25. The security element according to claim 24, characterized in that it is disposed detachably on a carrier layer.

26. The security element according to claim 24, characterized in that it is formed as a label, seal, transfer band, sleeve or other flat transfer element.

27. A security paper for producing security or value documents, having a machine-readable authenticity mark as described in claim 1.

28. A method for checking the authenticity of a value document, according to claim 1 or a security element in said value document or a security pa per encompassing said value document, characterized by the following steps:
irradiating the machine-readable authenticity mark with infrared radiation from the excitation range of the luminescent marking substance,
determining the emission of the authenticity mark at a wavelength from the emission range, and
evaluating the authenticity of the value document, security element or security paper on the basis of the determined emission.

29. The method according to claim 28, characterized in that the determination of the emission is carried out in spatially resolved fashion.

30. The method according to claim 28, characterized in that the emission of the authenticity mark is determined on two opposite sides of the value document, security element or security paper.

31. The method according to claim 30, characterized in that the authenticity evaluation is carried out on the basis of a comparison of the emission from the opposite sides.

32. A method for checking the authenticity of a value document, according to claim 1, or of a security element in said value document or a security paper encompassing said value document, characterized by the following steps:
irradiating the machine-readable authenticity mark with infrared radiation from the absorption range of the infrared absorbing marking substance,
determining the absorption of the authenticity mark at a wavelength from the irradiation range, and
evaluating the authenticity of the value document, security element or security paper on the basis of the determined absorption.

33. The method according to claim 32, characterized in that the absorption of the authenticity mark is determined via a measurement of the transmitted and/or remitted infrared radiation.

34. A method for checking the authenticity of a value document, according to claim 1, or of a security element in said value document or a security paper encompassing said value document characterized by the following steps:
irradiating the machine-readable authenticity mark with infrared radiation from the excitation range of the luminescent marking substance,
determining the absorption of the authenticity mark at a wavelength from the absorption range of the infrared absorbing marking substance, and
evaluating the authenticity of the value document, security element or security paper on the basis of the determined absorption.

35. The method according to claim 34, characterized in that the determination of the absorption is carried out in spatially resolved fashion.

36. The method according to claim 28, characterized in that the absorption of the authenticity mark is determined additionally at a wavelength from the visible spectral range for authenticity testing.

37. The method according to claim 28, characterized in that the irradiation is carried out with a light-emitting diode or a laser diode.

38. The method according to claim 28, characterized in that the arrangement of the infrared absorbing marking substance represents information, which is read by determining the absorption or emission and used for authenticity testing.

39. The method according to claim 38, characterized in that the information comprises the denomination, the currency, the emission date, the country, the printing works or special features of the value document, security element or security paper, whereby one or more of the stated pieces of information are read and processed further in authenticity testing.

40. An apparatus for carrying out the method according to claim 28, having means for irradiating the machine-readable authenticity mark with infrared radiation from the excitation range of the luminescent marking substance, means for determining the emission of the authenticity mark at a wavelength from the emission range, and means for evaluating the authenticity of the value document, security element or security paper on the basis of the determined emission.

41. An apparatus for carrying out the method according to claim 32, having means for irradiating the machine-readable authenticity mark with infrared radiation from the absorption range of the infrared absorbing marking substance, means for determining the absorption of the authenticity mark at a wavelength from the irradiation range, and means for evaluating the authenticity of the value document, security element or security paper on the basis of the determined emission.

42. An apparatus for carrying out the method according to claim 34, having means for irradiating the machine-readable authenticity mark with infrared radiation from the excitation range of the luminescent marking substance, means for determining the absorption of the authenticity mark at a wavelength from the absorption range of the infrared absorbing marking substance, and means for evaluating the authenticity of the value document, security element or security paper on the basis of the determined absorption.

43. The apparatus according to claim 40 in form of a money processing machine, a bank note counting machine, a bank note sorting machine, a bank note reading device for the blind or partially sighted, a bank note reading device for dealings in foreign currency, or a pocket-size bank note testing device.

44. (canceled)

45. The value document of claim 1 wherein the luminescent marking substance emits at a wavelength λ of 880 nm.

46. The value document of claim 1 wherein said luminescent marking substance emits at a wavelength above about 1100 nm.

47. The value document of claim 46 wherein said wavelength is above about 1200 nm.

48. The value document of claim 3 wherein said spectral range is from about 800 nm to about 1000 nm.

49. The value document of claim 13 wherein said substrate is a paper substrate.

50. The value document of claim 14 wherein the infrared absorbing marking substance is printed on the value document.

51. The value document of claim 15 wherein said information comprises patterns, signs or codings.

52. The value document of claim 51 wherein said information comprises a barcode.

53. The value document of claim 22 wherein said area is a surface area of 100 mm² or more.

54. The value document of claim 53 wherein said surface area is 400 mm² or more.

55. The value document of claim 23 wherein said coverage is about 50%.

56. The security paper of claim 27 wherein said security or value documents comprise banknotes or identity cards.

57. The method of claim 38 wherein said information comprises a barcode.
